(19) United States
(12) Patent Application Publication
(10) Pub. No.: US 2015/0061598 A1
(43) Pub. Date: Mar. 5, 2015

(54) MCM-48 SILICA PARTICLE COMPOSITIONS, ARTICLES, METHODS FOR MAKING AND METHODS FOR USING

(71) Applicant: E I DU PONT DE NEMOURS AND COMPANY, Wilmington, DE (US)

(72) Inventor: Cheng-Yu Lai, West Grove, PA (US)

(21) Appl. No.: 14/384,719

(22) PCT Filed: Mar. 8, 2013
(86) PCT No.: PCT/US13/29754

§ 371 Date: Sep. 12, 2014

Related U.S. Application Data
(60) Provisional application No. 61/610,638, filed on Mar. 14, 2012.

(51) Int. Cl. H01M 10/42; H02J 7/00; H01M 4/62; H01M 4/58; H01M 4/36; H01M 2/16

(52) U.S. Cl. CPC H01M 10/4235; H01M 4/364; H01M 2/166; H01M 4/628; H01M 4/624; H01M 4/5815; H02J 7/0063; H01M 10/0525
USPC 320/127; 429/7; 502/1; 29/623.1

(57) ABSTRACT

There is a composition comprising mesoporous silica particles. The particles may have a MCM-48 three-dimensional framework and be characterized by having a surface area of about 300 to 2,000 square meters per gram, a pore volume of about 0.5 to 1.5 cubic centimeters per gram, an average pore diameter dimension of about 1 to 20 nanometers, and an average particle size of about 5 to 2,000 nanometers based on the average diameter of the silica particles. There is also a lithium-sulfur cell comprising an article comprising mesoporous silica particles. The cell also comprises a negative electrode, a circuit coupled with the negative electrode, a lithium-containing electrolyte medium and an interior wall of the cell. There are also associated methods of making and methods of using the silica particles and the cell.

### CROSS-REFERENCE TO RELATED APPLICATIONS

This application claims priority to and the benefit of the filing date of U.S. Provisional Application Nos. 61/610,638, filed on Mar. 14, 2012, the entirety of which is herein incorporated by reference.

### BACKGROUND OF THE INVENTION

There is significant interest in lithium sulfur (i.e., “Li—S”) batteries as potential portable power sources for their applicability in different areas. These areas include emerging areas, such as electrically powered automobiles and portable electronic devices, and traditional areas, such as car ignition batteries. Li—S batteries offer great promise in terms of cost, safety and capacity, especially compared with lithium ion battery technologies not based on sulfur. For example, elemental sulfur is often used as a source of electroactive sulfur in a Li—S cell of a Li—S battery. The theoretical charge capacity associated with electroactive sulfur in a Li—S cell based on elemental sulfur is about 1,672 mAh/g S. In comparison, a theoretical charge capacity in a lithium ion battery based on a metal oxide is often less than 250 mAh/g metal oxide. For example, the theoretical charge capacity in a lithium ion battery based on the metal oxide species LiFePO₄ is 176 mAh/g.

A Li—S battery includes one or more electrochemical voltaic Li—S cells which derive electrical energy from chemical reactions occurring in the cells. A cell includes at least one positive electrode. When a new positive electrode is initially incorporated into a Li—S cell, the electrode includes an amount of sulfur compound incorporated within its structure. The sulfur compound includes potentially electroactive sulfur which can be utilized in operating the cell. A negative electrode in a Li—S cell commonly includes lithium metal. In general, the cell includes a cell solution with one or more solvents and electrolytes. The cell also includes one or more porous separators for separating and electrically isolating the positive electrode from the negative electrode, but permitting diffusion to occur between them in the cell solution. Generally, the positive electrode is coupled to at least one negative electrode in the same cell. The coupling is commonly through a conductive metallic circuit.

Li—S cell configurations also include, but are not limited to, those having a negative electrode which initially does not include lithium metal, but includes another material. Examples of these materials are graphite, silicon-alloy and other metal alloys. Other Li—S cell configurations include those with a positive electrode incorporating a lithiated sulfur compound, such as lithium sulfide (i.e., Li₂S).

The sulfur chemistry in a Li—S cell involves a related series of sulfur compounds. During a discharge phase in a Li—S cell, lithium is oxidized to form lithium ions. At the same time larger or longer chain sulfur compounds in the cell, such as S₈ and Li₂S₈, are electrochemically reduced and converted to smaller or shorter chain sulfur compounds. In general, the reactions occurring during discharge may be represented by the following theoretical discharging sequence of the electrochemical reduction of elemental sulfur to form lithium polysulfides and lithium sulfide:

S₈→Li₂S₈→Li₂S₆→Li₂S₄→Li₂S₃→Li₂S₂→Li₂S

During a charge phase in a Li—S cell, a reverse process occurs. The lithium ions are drawn out of the cell solution. These ions may be plated out of the solution and back to a metallic lithium negative electrode. The reactions may be represented, generally, by the following theoretical charging sequence representing the electrooxidation of the various sulfides to elemental sulfur:

Li₂S→Li₂S₂→Li₂S₃→Li₂S₄→Li₂S₆→Li₂S₈→S₈

A common limitation of previously-developed Li—S cells and batteries is capacity degradation or capacity “fade”. Capacity fade is associated with coulombic efficiency, the fraction or percentage of the electrical charge stored by charging that is recoverable during discharge. It is generally believed that capacity fade and coulombic efficiency are due, in part, to sulfur loss through the formation of certain soluble sulfur compounds which “shuttle” between electrodes in a Li—S cell and react to deposit on the surface of a negative electrode. It is believed that these deposited sulfides can obstruct and otherwise foul the surface of the negative electrode and may also result in sulfur loss from the total electroactive sulfur in the cell. The formation of anode-deposited sulfur compounds involves complex chemistry which is not completely understood.

In addition, low coulombic efficiency is another common limitation of Li—S cells and batteries. A low coulombic efficiency can be accompanied by a high self-discharge rate. It is believed that low coulombic efficiency is also a consequence, in part, of the formation of the soluble sulfur compounds which shuttle between electrodes during charge and discharge processes in a Li—S cell.

Some previously-developed Li—S cells and batteries have utilized high loadings of sulfur compound in their positive electrodes in attempting to address the drawbacks associated with capacity degradation and anode-deposited sulfur compounds. However, simply utilizing a higher loading of sulfur compound presents other difficulties, including a lack of adequate containment for the entire amount of sulfur compound in the high loading. Furthermore, positive electrodes formed using these compositions tend to crack or break. Another difficulty may be due, in part, to the insulating effect of the higher loading of sulfur compound. The insulating effect may contribute to difficulties in realizing the full capacity associated with all the potentially electroactive sulfur in the high loading of sulfur compound in a positive electrode of these previously-developed Li—S cell and batteries.

Conventionally, the lack of adequate containment for a high loading of sulfur compound has been addressed by utilizing higher amounts of binder in compositions incorporated into these positive electrodes. However, a positive electrode incorporating a high binder amount tends to have a lower sulfur utilization which, in turn, lowers the effective maximum discharge capacity of the Li—S cells with these electrodes.

Li—S cells and batteries are desirable based on the high theoretical capacities and high theoretical energy densities of the electroactive sulfur in their positive electrodes. However, attaining the full theoretical capacities and energy densities remains elusive. Furthermore, as mentioned above, the sulfide shuttling phenomena present in Li—S cells (i.e., the movement of polysulfides between the electrodes) can result in relatively low coulombic efficiencies for these electrochemical cells; and this is typically accompanied by undesirably high self-discharge rates. In addition, the concomitant limitations associated with capacity degradation, anode-deposited sulfur compounds and the poor conductivities intrinsic to sulfur compound itself, all of which are associated with previously-developed Li—S cells and batteries, limits the application and commercial acceptance of Li—S batteries as power sources.

Given the foregoing, what are needed are Li—S cells and batteries without the above-identified limitations of previously-developed Li—S cells and batteries.

### BRIEF SUMMARY OF THE INVENTION

This summary is provided to introduce a selection of concepts. These concepts are further described below in the Detailed Description. This summary is not intended to identify key features or essential features of the claimed subject matter, nor is this summary intended as an aid in determining the scope of the claimed subject matter.

The present invention meets the above-identified needs by providing mesoporous silica particles having a MCM-48 three-dimensional framework with select physical properties. The MCM-48 silica particles appear to be particularly useful in adsorbing soluble sulfur compounds in a Li—S cell. The present invention also provides articles in a Li—S cell, such as a positive electrode, a porous separator, a coating or a membrane which incorporate mesoporous silica particles, such as MCM-48 silica particles. In addition, the present invention provides methods for making and methods for using the MCM-48 silica particles and articles containing MCM-48 silica particles in a Li—S cell.

The mesoporous silica particles, such as the MCM-48 silica particles, when utilized in articles of Li—S cells, provide Li—S cells and batteries without the above-identified limitations of previously-developed Li—S cells and batteries. While not being bound by any particular theory, it is believed that the MCM-48 silica particles suppress the shuttling of soluble sulfur compounds and their arrival at negative electrodes in the Li—S cells by acting as reservoirs for soluble sulfur compounds present in the electrolyte medium. This reduces capacity fade through sulfur loss. Furthermore, low sulfur utilization and high discharge capacity degradation are avoided in these Li—S cells. These and other objects are accomplished by the MCM-48 silica particle compositions, articles incorporating MCM-48 silica particles, methods for making and methods for using such, in accordance with the principles of the invention.

According to a first principle of the invention, there is a composition comprising mesoporous silica particles. The particles may have a MCM-48 three-dimensional framework. The particles may be characterized by having a surface area of about 300 to 2,000 square meters per gram. The particles may be characterized by having a pore volume of about 0.5 to 1.5 cubic centimeters per gram. The particles may be characterized by having an average pore diameter dimension of about 1 to 20 nanometers. The particles may be characterized by having an average particle size of about 5 to 2,000 nanometers based on the average diameter of the silica particles. The particles may be characterized by at least one of the surface area being about 1,000 to 2,000 square meters per gram, the pore volume being about 1 to 1.5 cubic centimeters per gram, and the average pore diameter dimension being about 3 to 20 nanometers. The particles may be characterized by at least one of the surface area being about 1,100 to 2,000 square meters per gram, the pore volume being about 1.1 to 1.5 cubic centimeters per gram, and the average pore diameter dimension being about 3.2 to 20 nanometers. The particles may be characterized by at least one of the surface area being about 1,200 to 2,000 square meters per gram, the pore volume being about 1.3 to 1.5 cubic centimeters per gram, and the average pore diameter dimension being about 3.5 to 20 nanometers. The particles may be spherical. The particles may be made by a process utilizing silica precursor and a plurality of surfactants. The particles may be coated with a conductive polymer. The conductive polymer may be polyacrylonitrile.

According to a second principle of the invention, there is a lithium-sulfur cell. The cell may comprise one or more of a negative electrode, a circuit coupled with the negative electrode, a lithium-containing electrolyte medium, an interior wall of the cell and an article comprising mesoporous silica particles. The particles may have a MCM-48 three-dimensional framework. The particles may be characterized by at least one of a surface area of about 300 to 2,000 square meters per gram, a pore volume of about 0.5 to 1.5 cubic centimeters per gram, an average pore diameter dimension of about 1 to 20 nanometers and an average particle size of about 5 to 2,000 nanometers based on the average diameter of the silica particles. The article may be a porous separator. The porous separator may comprise at least one of polyimide, polyethylene and polypropylene. The particles may be incorporated into a surface coating on a surface of the article in an amount of about 0.0001 to 100 mg/cm² silica. The particles may be an additive incorporated within the porous separator. The silica particles may be located in a pore wall of a pore in the porous separator and exposed to electrolyte medium in the pore. The article may be a positive electrode and the silica particles may be part of a cathode composition incorporated into the positive electrode. The particles may be incorporated into a carbon-sulfur composite as a component of the cathode composition. The article may be a coating located on a surface of one or more of a porous separator, a positive electrode, the negative electrode, the circuit and the interior wall of the cell. The coating may have characteristics of a film and be located on a surface of one or more of the circuit, and the interior wall of the cell. The coating may have characteristics of a membrane and be located on a surface of one or more of the porous separator, the positive electrode, the negative electrode, the circuit, and the interior wall of the cell. The article may be situated in the electrolyte medium and be one of a film, a membrane, and a combination comprising characteristics of a film and a membrane in different parts of the combination.

According to a third principle of the invention, there is a method for making a lithium-sulfur cell. The method comprises fabricating a plurality of components to form the cell. The plurality comprises one or more of a negative electrode, a circuit coupled with the negative electrode, a lithium-containing electrolyte medium, an interior wall of the cell and an article comprising mesoporous silica particles. The particles may have a MCM-48 three-dimensional framework. The particles may be characterized by one or more of a surface area of about 300 to 2,000 square meters per gram, a pore volume of about 0.5 to 1.5 cubic centimeters per gram, an average pore diameter dimension of about 1 to 20 nanometers, and an average particle size of about 5 to 2,000 nanometers based on the average diameter of the silica particles.

According to a fourth principle of the invention, there is a method for using a lithium-sulfur cell. The method comprises one or more steps from the plurality of steps comprising converting chemical energy stored in the cell into electrical energy and converting electrical energy into chemical energy stored in the cell. The cell comprises one or more of a negative electrode, a circuit coupled with the negative electrode, a lithium-containing electrolyte medium, an interior wall of the cell and an article comprising mesoporous silica particles. The cell may be associated with one or more of a portable battery, a power source for an electrified vehicle, a power source for an ignition system of a vehicle and a power source for a mobile device. The particles may have a MCM-48 three-dimensional framework. The particles may be characterized by one or more of a surface area of about 300 to 2,000 square meters per gram, a pore volume of about 0.5 to 1.5 cubic centimeters per gram, an average pore diameter dimension of about 1 to 20 nanometers and an average particle size of about 5 to 2,000 nanometers based on the average diameter of the silica particles.

The above summary is not intended to describe each embodiment or every implementation of the present invention. Further features, their nature and various advantages will be more apparent from the accompanying drawings and the following detailed description of the examples and embodiments.

### BRIEF DESCRIPTION OF THE DRAWINGS

The features and advantages of the present invention become more apparent from the detailed description set forth below when taken in conjunction with the drawings in which like reference numbers indicate identical or functionally similar elements. Additionally, the left-most digit of a reference number identifies the drawing in which the reference number first appears.

In addition, it should be understood that the drawings in the figures which highlight the aspects, methodology, functionality and advantages of the present invention, are presented for example purposes only. The present invention is sufficiently flexible, such that it may be implemented in ways other than that shown in the accompanying figures.

FIG. 1 is a two-dimensional perspective of a Li—S cell containing several articles incorporating MCM-48 silica particles, according to an example;

FIG. 2 is a schematic of a perspective view of a MCM-48 three-dimensional framework, according to an example; and

FIG. 3 is a context diagram illustrating properties of a Li—S battery or cell containing an article incorporating MCM-48 silica particles, according to an example.

### DETAILED DESCRIPTION

The present invention is useful for certain energy storage applications, and has been found to be particularly advantageous for high maximum discharge capacity batteries which operate with high coulombic efficiency utilizing electrochemical voltaic cells which derive electrical energy from chemical reactions involving sulfur compounds. While the present invention is not necessarily limited to such applications, various aspects of the invention are appreciated through a discussion of various examples using this context.

For simplicity and illustrative purposes, the present invention is described by referring mainly to embodiments, principles and examples thereof. In the following description, numerous specific details are set forth in order to provide a thorough understanding of the examples. It is readily apparent however, that the embodiments may be practiced without limitation to these specific details. In other instances, some embodiments have not been described in detail so as not to unnecessarily obscure the description. Furthermore, different embodiments are described below. The embodiments may be used or performed together in different combinations.

The operation and effects of certain embodiments can be more fully appreciated from a series of examples, as described below. The embodiments on which these examples are based are representative only. The selection of those embodiments to illustrate the principles of the invention does not indicate that materials, components, reactants, conditions, techniques, configurations and designs, etc. which are not described in the examples are not suitable for use, or that subject matter not described in the examples is excluded from the scope of the appended claims and their equivalents. The significance of the examples can be better understood by comparing the results obtained therefrom with potential results which can be obtained from tests or trials that may be or may have been designed to serve as controlled experiments and provide a basis for comparison.

As used herein, the terms “based on”, “comprises”, “comprising”, “includes”, “including”, “has”, “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Also, use of the “a” or “an” is employed to describe elements and components. This is done merely for convenience and to give a general sense of the description. This description should be read to include one or at least one and the singular also includes the plural unless it is obvious that it is meant otherwise.

The meaning of abbreviations and certain terms used herein is as follows: “Å” means angstrom(s), “nm” means nanometer(s), “g” means gram(s), “mg” means milligram(s), “μg” means microgram(s), “L” means liter(s), “mL” means milliliter(s), “cc” means cubic centimeter(s), “cc/g” means cubic centimeters per gram, “mol” means mole(s), “mmol” means millimole(s), “M” means molar concentration, “wt. %” means percent by weight, “Hz” means hertz, “mS” means millisiemen(s), “mA” mean milliamp(s), “mAh/g” mean milliamp hour(s) per gram, “mAh/g S” mean milliamp hour(s) per gram sulfur based on the weight of sulfur atoms in a sulfur compound, “V” means volt(s), “x C” refers to a constant current that may fully charge/discharge an electrode in l/x hours, “SOC” means state of charge, “SEI” means solid electrolyte interface formed on the surface of an electrode material, “kPa” means kilopascal(s), “rpm” means revolutions per minute, “psi” means pounds per square inch, “maximum discharge capacity” is the maximum milliamp hour(s) per gram of a positive electrode in a Li—S cell at the beginning of a discharge phase (i.e., maximum charge capacity on discharge), “coulombic efficiency” is the fraction or percentage of the electrical charge stored in a rechargeable battery by charging and is recoverable during discharging and is expressed as 100 times the ratio of the charge capacity on discharge to the charge capacity on charging, “pore volume” (i.e., Vp) is the sum of the volumes of all the pores in one gram of a substance and may be expressed as cc/g, “porosity” (i.e., “void fraction”) is either the fraction (0-1) or the percentage (0-100%) expressed by the ratio: (volume of voids in a substance)/(total volume of the substance).

As used herein and unless otherwise stated the term “cathode” is used to identify a positive electrode and “anode” to identify a negative electrode of a battery or cell. The term “battery” is used to denote a collection of one or more cells arranged to provide electrical energy. The cells of a battery can be arranged in various configurations (e.g., series, parallel and combinations thereof).

The term “sulfur compound” as used herein refers to any compound that includes at least one sulfur atom, such as elemental sulfur and other sulfur compounds, such as lithiated sulfur compounds including disulfide compounds and polysulfide compounds. For further details on examples of sulfur compounds particularly suited for lithium batteries, reference is made to “A New Entergy Storage Material: Organosulfur Compounds Based on Multiple Sulfur-Sulfur Bonds”, by Naoi et al., J. Electrochem. Soc., Vol. 144, No. 6, pp. L170-L172 (June 1997), which is incorporated herein by reference in its entirety.

According to the principles of the invention, as demonstrated in the following examples and embodiments, there are compositions comprising mesoporous silica particles having a MCM-48 three-dimensional framework. The MCM-48 silica particles may be characterized as having high surface area, large pore volume and large dimensions associated with the pore diameter or average pore diameter of pores within the MCM-48 framework. According to an embodiment, the MCM-48 silica particles may be characterized as spherical. According to another embodiment, the MCM-48 silica particles may be coated with conductive polymer.

The MCM-48 silica particles are particularly useful for addressing the problem of sulfur loss in Li—S cells associated with sulfur compounds shuttling in an electrolyte medium of a Li—S cell, such as cell 100. Without being bound by any particular theory, it appears that the migrating sulfur compounds adhere through adsorption to the walls of the MCM-48 three-dimensional framework or a coated variation thereof. The MCM-48 silica particles thus inhibit shuttling sulfur compounds from reaching and depositing on a negative electrode in the cell, such as negative electrode 101, thus avoiding sulfur loss and capacity degradation.

The MCM-48 silica particles may be incorporated as an additive into one or more articles of a Li—S cell. When incorporated in an article within the Li—S cell, the silica particles may be exposed to the electrolyte medium in the cell and thus come into contact with soluble sulfur compounds shuttling in the electrolyte medium. MCM-48 silica particles in an article which are exposed to the electrolyte medium in the cell may therefore be utilized for their reservoir properties with respect to soluble sulfur compounds shuttling through the electrolyte medium in the cell.

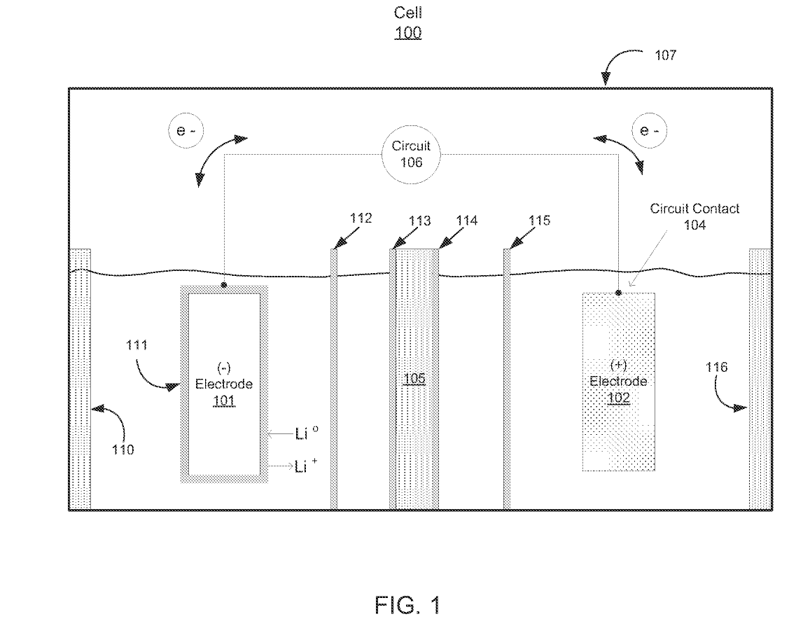

Referring to FIG. 1, depicted is cell 100, a Li—S cell in a Li—S battery. Cell 100 includes a lithium containing negative electrode 101, a sulfur-containing positive electrode 102, a circuit 106 and a porous separator 105. A cell container wall 107 contains the elements in the cell 100 within an electrolyte medium, such as a cell solution comprising solvent and electrolyte. The positive electrode 102 includes a circuit contact 104. The circuit contact 104 provides a conductive conduit through the circuit 106 coupling the negative electrode 101 and the positive electrode 102. The positive electrode 102 is operable in conjunction with the negative electrode 101 to store and release electrochemical voltaic energy. These electrodes both operate together in converting chemical and electrical energy from one form to the other, depending upon whether the cell 100 is in a charge phase or discharge phase in a charge-discharge cycle.

According to an embodiment, a porous carbon material, such as a carbon powder having a high surface area and a high pore volume, may be utilized for making the positive electrode 102. Sulfur compound, such as elemental sulfur, lithium sulfide, and combinations of such, may be introduced to the porous regions within the carbon powder to make a carbon-sulfur (i.e., C—S) composite. The C—S composite is then incorporated into a cathode composition used to form the positive electrode 102. A polymeric binder may be combined with the C—S composite in the cathode composition for the positive electrode 102. Alternatives to carbon powder may be utilized to host the sulfur compound in the positive electrode 102. Alternatives to carbon powder include graphite, graphene and carbon fibers. The carbon structure used to host the sulfur compound in the positive electrode 102 need not be a C—S composite and the construction of the positive electrode 102 may be varied as desired.

Mesoporous silica particles, such as MCM-48 silica particles, may be incorporated into the positive electrode 102 in cell 100, as shown in FIG. 1. The MCM-48 silica particles may be incorporated through various means into the positive electrode 102. In one example, the silica particles may be incorporated as an additive to a C—S composite and is incorporated within the carbon host material of the composite. In another example, the silica particles may be combined as a component in a cathode composition with previously formed C—S composite and polymeric binder. Similarly, mesoporous silica particles, such as MCM-48 silica particles, may be incorporated into other articles for use in a Li—S cell, as an alternative or in addition to a positive electrode.

Mesoporous silica particles, such as MCM-48 silica particles, may be incorporated within or near the surface of the porous separator 105 and the cell container wall 107. The particles can be incorporated during the formation of these elements prior to assembling the Li—S cell 100, or after the cell is assembled, such as by coating the elements with MCM-48 silica particles in a coating composition. MCM-48 silica particles which are incorporated into the container wall 107, the positive electrode 102 and the porous separator 105 may all be utilized during an operation of the cell 100 for their reservoir properties with respect to shuttling sulfur compounds in the electrolyte medium. The reservoir properties of the silica particles are particularly useful during a discharge phase in the cell 100 for inhibiting the migration of shuttling sulfur compounds toward the negative electrode 101.

When situated within the interior of the porous separator 105, mesoporous silica particles, such as MCM-48 silica particles, may be exposed to electrolyte medium contained within or passing through a pore volume of the porous separator 105. The exposed silica particles within the porous separator 105 appear to function as a barrier to limit the passage of soluble sulfur compounds shuttling through the pore volume from reaching the negative electrode 101. However, the silica particles in the porous separator 105 still permit diffusion of lithium ions through the same pore volumes crossing through the porous separator 105. This same selective barrier property of mesoporous silica particles, such as MCM-48 silica particles, may be utilized in other porous or permeable articles in the cell 100.

Membrane 111 is an anodic-membrane comprising mesoporous silica particles, such as MCM-48 silica particles. Membrane 111 is affixed or in close proximity to a surface of the negative electrode 101. Membrane 111 is porous to allow passage of lithium ions, yet contains mesoporous silica particles which inhibit the passage of shuttling sulfur compounds from reaching the negative electrode 101 due to their reservoir properties. According to an embodiment, membrane 111 includes a protective layer, separating lithium metal in negative electrode 101 from an outer portion of membrane 111. The outer portion of membrane 11 may contain MCM-48 silica particles as well as substances which might react with the lithium metal in the negative electrode 101. The protective layer in membrane 111 comprises a permeable substance which is substantially inert to the lithium metal in the negative electrode 101. Suitable inert substances include porous films containing materials such as polypropylene and polyethylene. The membrane 111 contains mesoporous silica particles, such as MCM-48 silica particles, exposed to the electrolyte medium in cell 100. Thus, membrane 111 can function as a barrier or reservoir to shuttling sulfur compounds from reaching the negative electrode 101 by limiting their passage along the surface or through pores in the membrane 111. However, membrane 111 permits diffusion of lithium ions to and from the negative electrode 101.

Coatings 113 and 114 also comprise mesoporous silica, such as MCM-48 silica particles. These coatings are applied to respective separate surfaces of the porous separator 105. The coatings 113 and 114 may be applied through various well-known techniques such as spray coating, dip coating and the like. Coatings 113 and 114 comprise base materials in which the silica particles are situated, such as a binder or coating composition. Like membrane 111, coatings 113 and 114 are permeable, but appear to function as a barrier to soluble sulfur compounds from reaching the negative electrode 101 by limiting their passage by diffusion through the electrolyte medium. The coatings 113 and 114 may also function as reservoirs for sulfur compounds, possibly through adsorption by the silica particles or by otherwise limiting the passage of soluble sulfur compounds through pores in the coatings. At the same time, the coatings 113 and 114 permit the diffusion of lithium ions through their pores.

Membranes 112 and 115 comprise mesoporous silica, such as MCM-48 silica particles, and are fully situated within the electrolyte medium of the cell 100. Both membranes 112 and 115 are located between positive electrode 102 and the negative electrode 101, but on different sides of the porous separator 105. Membranes 112 and 115 may be secured within cell 100 by being affixed to another object in the cell 100, such as the cell container wall 107. Membranes 112 and 115 are permeable. However, they limit the passage of soluble sulfur compounds through the electrolyte medium and from reaching the negative electrode 101, possibly due to the reservoir properties of the silica particles. However, the membranes 112 and 115 permit the diffusion of lithium ions through their pores.

Films 110 and 116 comprise mesoporous silica particles, such as MCM-48 silica particles, and are situated in the cell 100 so as to be partially exposed to the cell solution. Films 110 and 116 do not separate the positive electrode 102 from the negative electrode 101, may be permeable or impermeable and contain silica particles on their surface which are exposed to the electrolyte medium. Thus they may function as reservoirs to soluble sulfur compounds, and limit their passage to reach the negative electrode 101. Without being bound by any particular theory, they appear to accomplish this through the adsorption of sulfur compounds from the electrolyte medium during charge-discharge cycles in the cell 100.

In MCM-48 silica particles, the three-dimensional pore system comprises two independent, yet intertwining, channel networks. The pore volumes of these channel networks are inter-connected, and thus are especially suited for adsorbing sulfur compounds from an electrolyte medium. According to an embodiment, the MCM-48 mesoporous silica particles have high surface area, large pore volume and large dimensions associated with a pore diameter or an average pore diameter of pores within the MCM-48 framework. These properties in MCM-48 particles, according to the embodiment, are particularly useful for adsorbing migrating sulfur compounds from an electrolyte medium yet permitting diffusion of lithium ions in a Li—S cell.

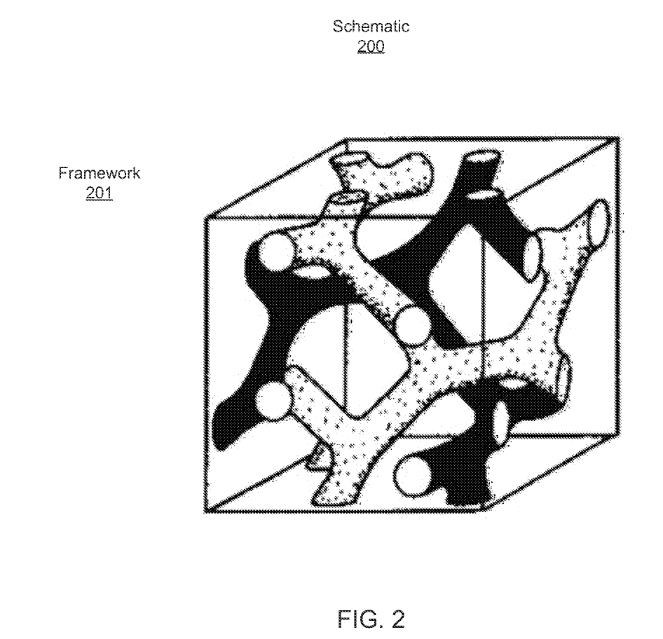

Referring to FIG. 2, depicted is schematic 200 demonstrating a perspective view of a MCM-48 three dimensional framework 201. MCM-48 is mesoporous silica having a three-dimensional framework with interconnecting pores and is described in U.S. Pat. No. 5,198,203, which is incorporated herein by reference in its entirety. MCM-48 is a subset of a family of mesoporous silica materials known by the family designation “M4 S”. In addition to MCM-48, other members of the M41S family include MCM-41 and MCM-50. The framework structure associated with the MCM-48 morphology differs from the respective framework structures associated with MCM-41 and MCM-50. MCM-41 has a hexagonal structure with a one-dimensional pore system, while MCM-50 has a lamellar structure. MCM-48 has a cubic Ia3d isometric spacing that forms a symmetrical structure in a three-dimensional pore system like that shown schematically in FIG. 2.

Mesoporous silica particles having a MCM-48 framework, such as those having the desirable properties of high surface area, large pore volume and large dimensions associated with pore diameter or average pore diameter of pores within the MCM-48 framework, can be synthesized via methods using a combination of different types of surfactants under select conditions using a variation on the Stöber method. The ordinary Stöber method is described in Shimura et al., “Preparation of surfactant templated nanoporous spherical particles by the Stöber method. Effect of solvent composition on the particle size”, J. Mater. Sci., No. 42, pp. 5299-5306 (2007), which is herein incorporated by reference in its entirety. In contrast, MCM-48 mesoporous silica particles having the desirable physical properties may be prepared utilizing silica precursor in an aqueous solution using different types of surfactants, as described below, under select conditions.

According to an example, two types of surfactants may be used. One type of surfactant is a cationic alkylated primary amine, such as a halogenated alkyl amine. Examples of the cationic surfactant type are hexadecyltrimethylammonium bromide (i.e., CTAB), hexadecyltrimethylammonium chloride, tetradecyltrimethylammonium chloride or bromide, and octadecyltrimethylammonium chloride or bromide. Various lengths of the alkyl chain in the cationic surfactant may be employed in the process to vary the properties of the MCM-48 framework in the mesoporous silica particles produced. A second type of surfactant used in the example method is a non-ionic block alkylene oxide polymer, such as a block copolymer of ethylene oxide and propylene oxide which is hydroxylated. Surfactants of this type are commercially available as PLURONIC® brand surfactants (BASF Chemical Company), such as PLURONIC F-127. Other non-ionic alkylene oxide polymer surfactants may also be used.

One or more silica precursors may be utilized in making the MCM-48 silica particles. A silica precursor is a silicon donating compound which donates silicon to form a silica matrix in the framework structure. Silica precursors suitable for use herein include various alkyl silanes. Examples of these silica precursors include tetraethyl orthosilicate (TEOS), tetramethyl orthosilicate (TMOS) and octyltrimethoxy silane.

In making the MCM-48 silica particles, the silica precursor and surfactants can be combined in an aqueous solution to form a mixture. The mixture may also contain one or more additional solvents to facilitate the formation of surfactant micelles and/or the donation of silicon from the silica precursor. Examples of such additives include alcohols and nitrogen-containing compounds. These are well known in the art. The mixture can also be treated so as to facilitate silica matrix formation using vehicles such as agitation, temperature, heat, light, etc. Depending on the additives and vehicles utilized, a period of time from a few minutes to several hours may be used to allow formation of the silica particles to develop. After this formation step, the MCM-48 silica particles can be recovered by separating the surfactants and other components in the solution from the silica particles formed. Recovery may be accomplished using well-known processes such as separation, washing, drying, etc.

As noted above, MCM-48 silica particles produced using the described process may be characterized as having high surface area, large pore volume and with large dimensions associated with the pore diameter or the average pore diameter of pores within the three-dimensional MCM-48 framework. These physical properties and the MCM-48 framework structure are especially suitable for utilization in Li—S cells by incorporating them into articles of the Li—S cells for their reservoir properties with respect to shuttling sulfur compounds.

The mesoporous silica particles, including the MCM-48 silica particles, suitable for use herein include those having a surface area of about 100 to 3,000 m²/g silica, about 200 to 2,500 m²/g, about 300 to 2,000 m²/g, about 500 to 2,000 m²/g, about 700 to 2,000 m²/g, about 900 to 2,000 m²/g, about 1000 to 2,000 m²/g, about 1.100 to 2,000 m²/g and about 1,200 to 2,000 m²/g carbon powder. Mesoporous silica particles, including MCM-48 silica particles, which are suitable for use herein include those having a surface area of about 400 m²/g silica, 600 m²/g, 800 m²/g, 1,000 m²/g, 1,100 m²/g, 1,200 m²/g, 1,300 m²/g, 1,400 m²/g, 1,600 m²/g, 1,800 m²/g, 2,000 m²/g, 2,200 m²/g, 2,400 m²/g, 2,600 m²/g, 2,800 m²/g, 3,000 m²/g, and about 3,200 m²/g silica.

The mesoporous silica particles, including the MCM-48 silica particles, suitable for use herein include those having a pore volume ranging from about 0.4 to 2 cc/g silica, from about 0.5 to 1.5 cc/g, from about 0.8 to 1.5 cc/g, from about 1 to 1.5 cc/g, from about 1.1 to 1.5 cc/g, from about 1.2 to 1.5 cc/g, from about 1.3 to 1.5 cc/g, and from about 1.4 to 1.5 cc/g silica. Mesoporous silica particles, including MCM-48 silica particles, which are suitable for use herein include those having a pore volume of about 0.4 cc/g silica, 0.4 cc/g, 0.5 cc/g, 0.6 cc/g, 0.7 cc/g, 0.8 cc/g, 0.9 cc/g, 1.0 cc/g, 1.1 cc/g, 1.2 cc/g, 1.3 cc/g, 1.4 cc/g, 1.5 cc/g, 1.6 cc/g, 1.7 cc/g, 1.8 cc/g, 1.9 cc/g and 2 cc/g silica.

The mesoporous silica particles, including the MCM-48 silica particles, suitable for use herein may be described in terms of the particle pore diameter(s) of pores in the MCM-48 three-dimensional framework. The pores may not be uniformly round or uniformly the same size, so the pores may be described as having an average dimension of an average pore diameter (i.e., an average pore diameter dimension). In an instance in which all the pores are substantially round and the same size, the average dimension is equivalent to the pore diameter. In an instance in which all the pores are substantially the same size, the average pore diameter is equivalent to the pore diameter. In an instance in which all the pores are substantially the same size and in which all the pores are substantially uniformly round, the average pore diameter dimension is equivalent to the pore diameter. Mesoporous silica particles, including MCM-48 silica particles, which are suitable for use herein, include those having an average pore diameter dimension of about 1 to 20 or 30 nanometers. These include those having an average pore diameter dimension of about 1 nm, 1.5 nm, 2 nm, 2.5 nm, 2.8 nm, 3 nm, 3.1 nm, 3.2 nm, 3.3 nm, 3.5 nm, 3.7 nm, 4 nm 5 nm, 6 nm, 8 nm, 10 nm, 12 nm, 14 nm, 16 nm, 18 nm, 20 nm, 25 nm and 30 nm.

Mesoporous silica particles, including MCM-48 silica particles, suitable for use herein may be described in terms of an average particle size of the particles made or utilized. The particles may be spheres or spherical, or have another geometrical configuration, such as ellipsoids, rods, etc. Accordingly, the silica particles may be described as having an average particle size based on an average diameter of a geometrical configuration of the particles. Mesoporous silica particles, including MCM-48 silica particles, suitable for use herein include those having an average particle size based on an average diameter of about 5 to 2,000 nanometers. These include those having an average particle size based on an average diameter of about 5 nm, 10 nm, 20 nm, 30 nm, 40 nm, 50 nm, 70 nm, 100 nm, 150 nm, 200 nm, 300 nm, 400 nm, 500 nm, 600 nm, 800 nm, 1,000 nm, 1,200 nm, 1.400 nm, 1,600 nm, 1,800 nm, 2,000 nm, 2,500 nm, 3,000 nm, 3,500 nm and 4,000 nm.

According to an embodiment, the silica particles may be coated with conductive coating polymer, such as by a melt-blend process, to form coated mesoporous silica particles, such as coated MCM-48 silica particles. Conductive coating polymers suitable for use herein include polyacrylonitrile (PAN) powder, such as “polyacrylonitrile” (Sigma-Aldrich, 181315). Other conductive coating polymers may also be used and are available from various commercial sources. Various conductive polymers and commercial sources are well known to those of ordinary skill in the art.

As noted above, the mesoporous silica particles, such as MCM-48 silica particles, may be combined with C—S composite in a cathode composition which is incorporated into the positive electrode 102 in cell 100. A C—S composite includes a porous carbon material, such as carbon powder, containing sulfur compound, such as elemental sulfur, situated in the carbon microstructure of the porous carbon material. The amount of sulfur compound which may be contained in the C—S composite (i.e., the sulfur loading in terms of the weight percentage of sulfur compound based on the total weight of the C—S composite) is dependent to an extent on the pore volume of the carbon powder. Accordingly, as the pore volume of the carbon powder increases, higher sulfur loading with more sulfur compound is possible. Thus, a sulfur compound loading of, for example, about 5 wt. %, 10 wt. %, 15 wt. %, 20 wt. %/, 25 wt. %, 30 wt. %, 35 wt. %, 40 wt. %, 45 wt. %, 50 wt. %, 55 wt. %, 60 wt. %, 65 wt. %, 70 wt. %, 75 wt. %, 80 wt. %, 85 wt. %, 85 wt. %, 90 wt. % or 95 wt. % may be used in the C—S composite. Other carbon materials, such as graphite, may also be used to host sulfur compound in the positive electrode 102.

The cathode composition may include various weight percentages of C—S composite based on carbon powder or another carbon host loaded with sulfur compound. In an embodiment, the weight percentage of C—S composite in the cathode composition ranges from about wt. 1% to about 99 wt. % of the composition. The cathode composition may include polymeric binder, carbon black and other optional components, in addition to the C—S composite. The loading of C—S composite in cathode composition may be varied as desired and generally is greater than 50 wt. % of the cathode composition. A C—S composite loading of, for example, about 50 wt. %, 55 wt. %, 60 wt. %, 65 wt. %, 70 wt. %, 75 wt. %, 80 wt. %, 85 wt. %, 90 wt. %, 95 wt. %, 98 wt. %, or 99 wt. % may be used. According to an embodiment, about 50 to 99 wt. % C—S composite may be used. In another embodiment, about 70 to 95 wt. % C—S composite may be used.

Referring again to FIG. 1, depicted is the positive electrode 102, incorporating a cathode composition as described above. The positive electrode 102 may be utilized in cell 100 in conjunction with a negative electrode, such as the lithium-containing negative electrode 101 described above. According to different embodiments, the negative electrode 101 may contain lithium metal or a lithium alloy. In another embodiment, the negative electrode 101 may contain graphite or some other non-lithium material. According to this embodiment, the positive electrode 102 is formed to include some form of lithium, such as lithium sulfide (Li₂S), which may be incorporated into a carbon powder to form a C—S composite.

One or more porous separators may be utilized in a Li—S cell, such as porous separator 105 depicted in the cell 100. The porous separator may be constructed from various materials. As an example, a mat or other porous article made from fibers, such as polyimide fibers, may be used as the porous separator 105. In other examples, porous laminates may be used as a porous separator, such as those made from polyvinylidene fluoride (PVDF), polyvinylidene fluoride co-hexafluoropropylene (PVDF-HFP), polyethylene (PE), polypropylene (PP), polyimide, and polymer blends.

Positive electrode 102, negative electrode 101 and porous separator 105 are in contact with a lithium-containing electrolyte medium in the cell 100, such as a cell solution with solvent and lithium ion electrolyte. In this embodiment, the lithium-containing electrolyte medium is a liquid. According to another embodiment, the lithium-containing electrolyte medium is a solid. In yet another embodiment, the lithium-containing electrolyte medium is a gel.

The lithium ion electrolyte may be non-carbon-containing. For example, the lithium ion electrolyte may be a lithium salt of such counter ions as hexachlorophosphate (PF₆⁻), perchlorate, chlorate, chlorite, perbromate, bromate, bromite, periodiate, iodate, aluminum fluorides (e.g., AlF₄⁻), aluminum chlorides (e.g. Al₂Cl₇⁻, and AlCl₄⁻), aluminum bromides (e.g., AlBr₄⁻), nitrate, nitrite, sulfate, sulfites, permanganate, ruthenate, perruthenate and the polyoxometallates.

In another embodiment, the lithium ion electrolyte may be carbon containing. For example, the lithium ion salt may contain organic counter ions such as carbonate, the carboxylates (e.g., formate, acetate, propionate, butyrate, valerate, lactacte, pyruvate, oxalate, malonate, glutarate, adipate, deconoate and the like), the sulfonates (e.g., CH₃SO₃⁻, CH₃CH₂SO₃⁻, CH₃(CH₂)₂SO₃⁻, benzene sulfonate, toluenesulfonate, dodecylbenzene sulfonate and the like. The organic counter ion may include fluorine atoms. For example, the lithium ion electrolyte may be a lithium ion salt of such counter anions as fluorosulfonates (e.g., CF₃SO₃⁻, CF₃CF₂SO₃⁻, CF₃(CF₂)₂SO₃⁻, CHF₂CF₂SO₃⁻ and the like), fluoroalkoxides (e.g., CF₃O⁻, CF₃CH₂O⁻, CF₃CF₂O⁻ and pentafluorophenolate), and fluorocarboxylates (e.g., trifluoroacetate and pentafluoropropionate) and fluorosulfonimides (e.g., (CF₃SO₂)₂N⁻). Other electrolytes which are suitable for use herein are disclosed in U.S. Published Patent Applications 2010/0035162 and 2011/00052998 both of which are incorporated herein by reference in their entireties.

The electrolyte medium may exclude a protic solvent, since protic liquids are generally reactive with the lithium anode. Solvents are preferred which can dissolve the electrolyte salt. For instance, the solvent may include an organic solvent such as polycarbonate, an ether or mixtures thereof. In other embodiments, the electrolyte medium may include a non-polar liquid. Some examples of non-polar liquids include the liquid hydrocarbons, such as pentane, hexane and the like.

Electrolyte preparations suitable for use in the cell solution may include one or more electrolyte salts in a nonaqueous electrolyte composition. Suitable electrolyte salts include without limitation: lithium hexafluorophosphate, LiPF₃(CF₂CF₃)₃, lithium bis(trifluoromethanesulfonyl)imide, lithium bis(perfluoroethanesulfonyl)imide, lithium (fluorosulfonyl) (nonafluoro-butanesulfonyl)imide, lithium bis(fluorosulfonyl)imide, lithium tetrafluoroborate, lithium perchlorate, lithium hexafluoroarsenate, lithium trifluoromethanesulfonate, lithium tris(trifluoromethanesulfonyl)methide, lithium bis(oxalato)borate, lithium difluoro(oxalato)borate, Li₂B₁₂F₁₂₋ₓHₓ where x is equal to 0 to 8, and mixtures of lithium fluoride and anion receptors such as B(OC₆F₅)₃. Mixtures of two or more of these or comparable electrolyte salts can also be used. In one embodiment, the electrolyte salt is lithium bis(trifluoromethanesulfonyl)imide). The electrolyte salt may be present in the nonaqueous electrolyte composition in an amount of about 0.2 to about 2.0 M, more particularly about 0.3 to about 1.5 M, and more particularly about 0.5 to about 1.2 M.

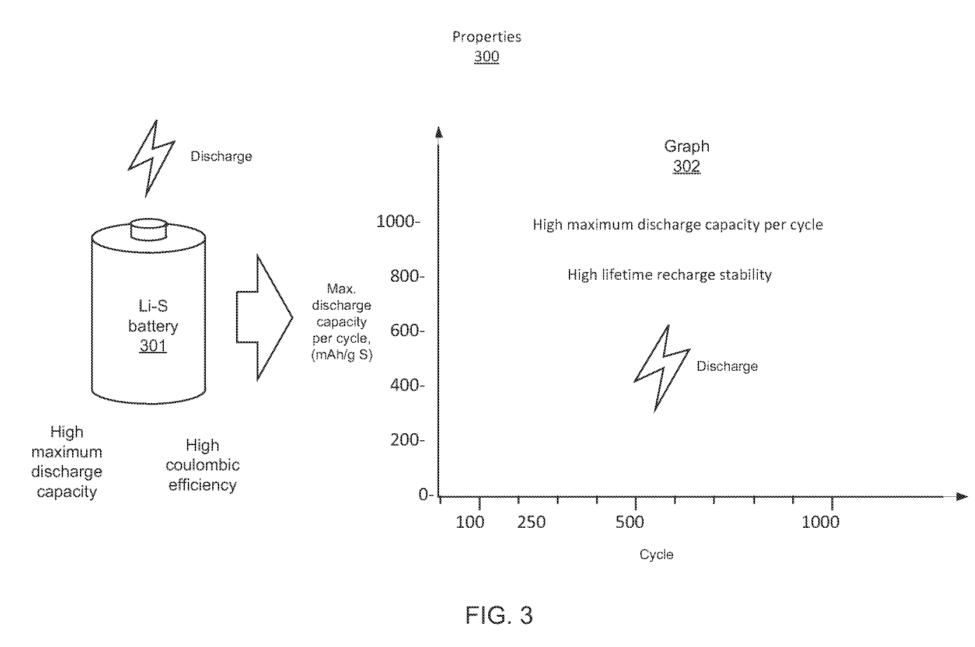

Referring to FIG. 3, depicted is a context diagram illustrating properties 300 of a Li—S battery 301 comprising a Li—S cell, such as cell 100, having one or more articles within the cell which incorporate mesoporous silica particles, such as particles having a MCM-48 three-dimensional framework with high surface area, large pore volume and large average pore diameter dimension. FIG. 3 demonstrates that properties 300 of Li—S battery 301 include both high coulombic efficiency and high maximum discharge capacity. The high coulombic efficiency appears to be directly attributable to the presence of the mesoporous silica particles in the articles within a cell of Li—S battery 301. FIG. 3 also depicts a graph 302 demonstrating maximum discharge capacity per cycle with respect to a number of charge-discharge cycles of the Li—S battery 301. The Li—S battery 301 exhibits high lifetime recharge stability and a high maximum discharge capacity per charge-discharge cycle.

### Example 1

Example 1 describes the preparation of silica particles having a MCM-48 three-dimensional framework with high surface area, large pore volume and large average pore diameter dimension using process of making that is a double surfactant variation on the Stöber method.

### Preparation of MCM-48 Silica Particles

Approximately 1.0 g of cetyltrimethylammonium bromide (CTAB) surfactant and 4.0 g alkylene oxide triblock copolymer (PLURONIC F127) surfactant were mixed in 350 mL of an aqueous solution including 225 mL water, 25 mL ammonium and 100 mL ethyl alcohol. 4 grams of tetraethylorthosilicate (TEOS) was added to the solution at room temperature. After vigorous stirring for 80 seconds, the entire mixture was kept under static conditions for 20 hours at room temperature to allow for complete condensation of the silica. The resulting solid silica product was collected, washed extensively with water and then dried at 80° C. in air. The solid silica product was then calcined for 6 hours at 550 hour ° C. in air to remove any remaining surfactant. The resulting silica particles where spherical in shape and had a MCM-48 three-dimensional framework with a surface area of greater than 1,000 m2/g, a pore volume of 1-2 to cc/g and a pore diameter of 3-4 nm.

### Example 2

Example 2 describes the preparation of coated MCM-48 silica particles using the MCM-48 silica particles of example 1 and a conductive coating polymer.

### Preparation of Coated MCM-48 Silica Particle

An amount of the MCM-48 silica particles from example 1 was combined at 280-300° C. with polyacrylonitrile powder to form a mixture. This mixture was held at this temperature for 6 hours in an argon atmosphere to form coated MCM-48 silica particles.

Utilizing compositions comprising mesoporous silica particles, such as MCM-48 silica particles, in articles of Li—S cells in Li—S batteries provides high maximum discharge capacity Li—S batteries having high coulombic efficiency. Li—S cells comprising articles incorporating the mesoporous silica particles may be utilized in a broad range of Li—S battery applications in providing a source of power for many household and industrial applications. The Li—S batteries including cells with articles incorporating mesoporous silica particles are especially useful as power sources for small electrical devices such as cellular phones, cameras and portable computing devices. They may also be used as power sources for car ignition batteries and for electrified cars.

Although described specifically throughout the entirety of the disclosure, the representative examples have utility over a wide range of applications and the above discussion is not intended and should not be construed to be limiting. The terms, descriptions and figures used herein are set forth by way of illustration only and are not meant as limitations. Those skilled in the art recognize that many variations are possible within the spirit and scope of the examples. While the examples have been described with reference to figures, those skilled in the art are able to make various modifications to the described examples without departing from the scope of the following claims, and their equivalents.

Further, the purpose of the foregoing Abstract is to enable the U.S. Patent and Trademark Office and the public generally and especially the scientists, engineers and practitioners in the relevant arts who are not familiar with patent or legal terms or phraseology, to determine quickly from a cursory inspection the nature and essence of this technical disclosure. The Abstract is not intended to be limiting as to the scope of the present invention in any way.

1. A composition comprising mesoporous silica particles having a MCM-48 three-dimensional framework, wherein the particles are characterized by having
a surface area of about 300 to 2,000 square meters per gram,
a pore volume of about 0.5 to 1.5 cubic centimeters per gram,
an average pore diameter dimension of about 1 to 20 nanometers, and
an average particle size of about 5 to 2,000 nanometers based on the average diameter of the particles; and wherein the particles are coated with a conductive polymer.

2-4. (canceled)

5. The composition of claim 1, wherein the particles are spherical.

6-7. (canceled)

8. The composition of claim 1, wherein the conductive polymer is polyacrylonitrile.

9. A lithium-sulfur cell, comprising:
a negative electrode;
a circuit coupled with the negative electrode;
a lithium-containing electrolyte medium;
an interior wall of the cell; and
an article comprising mesoporous silica particles.

10. The cell of claim 9, wherein the particles have a MCM-48 three-dimensional framework.

11. The cell of claim 9, wherein the particles are characterized by at least one of
a surface area of about 300 to 2,000 square meters per gram,
a pore volume of about 0.5 to 1.5 cubic centimeters per gram,
an average pore diameter dimension of about 1 to 20 nanometers, and
an average particle size of about 5 to 2,000 nanometers based on the average diameter of the particles.

12. The cell of claim 9, wherein the article is a porous separator.

13. The cell of claim 12, wherein the porous separator comprises at least one of polyimide, polyethylene and polypropylene.

14. The cell of claim 9, wherein the particles are incorporated into a surface coating on a surface of the article in an amount of about 0.0001 to 100 mg/cm² silica.

15. The cell of claim 12, wherein the particles are an additive incorporated within the porous separator.

16. (canceled)

17. The cell of claim 9, wherein the article is a positive electrode and the particles are part of a cathode composition incorporated into the positive electrode.

18. (canceled)

19. The cell of claim 9, wherein the article is a coating located on a surface of at least one of
a porous separator,
a positive electrode,
the negative electrode,
the circuit, and
the interior wall of the cell.

20. The cell of claim 19, wherein the coating has characteristics of a film and is located on a surface of at least one of
the circuit, and
the interior wall of the cell.

21. The cell of claim 19, wherein the coating has characteristics of a membrane and is located on a surface of at least one of
the porous separator,
the positive electrode,
the negative electrode,
the circuit, and
the interior wall of the cell.

22. The cell of claim 9, wherein the article is situated in the electrolyte medium and is one of
a film,
a membrane, and
a combination comprising characteristics of a film and a membrane in different parts of the combination.

23. A method for making a lithium-sulfur cell, comprising:
fabricating a plurality of components to form the cell, wherein the plurality comprises
a negative electrode,
a circuit coupled with the negative electrode,
a lithium-containing electrolyte medium,
an interior wall of the cell, and
an article comprising mesoporous silica particles.

24. The method of claim 23, wherein the particles have a MCM-48 three-dimensional framework and are characterized by at least one of
a surface area of about 300 to 2,000 square meters per gram,
a pore volume of about 0.5 to 1.5 cubic centimeters per gram,
an average pore diameter dimension of about 1 to 20 nanometers, and
an average particle size of about 5 to 2,000 nanometers based on the average diameter of the particles.

25. (canceled)

26. A method for using a lithium-sulfur cell, comprising at least one step from the plurality of steps comprising
converting chemical energy stored in the cell into electrical energy; and
converting electrical energy into chemical energy stored in the cell, wherein the cell comprises
a negative electrode,
a circuit coupled with the negative electrode,
a lithium-containing electrolyte medium,
an interior wall of the cell, and
an article comprising mesoporous silica particles.

27. The method of claim 26, wherein the cell is associated with at least one of a portable battery, a power source for an electrified vehicle, a power source for an ignition system of a vehicle and a power source for a mobile device.

28-29. (canceled)
